(19) United States
(12) Patent Application Publication
(10) Pub. No.: US 2015/0012536 A1
(43) Pub. Date: Jan. 8, 2015

(54) GROUP DECISION METHOD ON RANKING OF A LARGE NUMBER OF ALTERNATIVES

(71) Applicant: National Tsing Hua University, Hsinchu (TW)

(72) Inventors: Yi-Feng HUNG, Hsinchu (TW); Ming-Hsuan WANG, Hsinchu (TW)

(21) Appl. No.: 13/935,986

(22) Filed: Jul. 5, 2013

(51) Int. Cl. G06F 17/30

(52) U.S. Cl. CPC G06F 17/30598
USPC 707/737

(57) ABSTRACT

In a group decision method on ranking of a large number of alternatives, multiple alternatives are re-grouped into subgroups, and each alternative in every subgroup are evaluated based on information of each alternative to generate a ranking number for each alternative in every subgroup. Then, a normalized score for each alternative in every subgroup are determined to generate an average normalized score for each alternative, so as to increase the accuracy of ranking results of alternatives in a large scale competition.

### BACKGROUND OF THE INVENTION

1. Field of the Invention

The present invention relates to the technical field of group decision and, more particularly, to a group decision method on ranking of a large number of alternatives.

2. Description of Related Art

Generally, in a competition, many alternatives are reviewed and ranked to generate a ranking number for each alternative. In a small scale competition, all of the alternatives can be evaluated in the same standard. However, if the number of alternatives in a competition is large, it is impossible to review the materials of all the alternatives in one evaluation process. To reduce the workload of the evaluation, in a large scale competition, all of alternatives in a group are divided into a plurality of subgroups, and each alternative of every subgroup is reviewed, evaluated, and ranked by one evaluation process. Thus, alternatives in the same subgroup are evaluated in the same standard.

However, in one evaluation process, there may be different preferences and focuses. In the prior art, in order to avoid the evaluating result from being dominated by a single evaluation, each alternative should be evaluated by more than one evaluation process. Thus, each subgroup is evaluated by more than one time. The alternatives in a subgroup remain the same throughout the evaluation processes. After that, if the average scores of different subgroups are about the same, the alternatives are sorted by average score graded by the evaluation processes. However, if there are significant differences among the average scores and the standard deviations of different subgroups, certain normalization scheme is adopted to make the means and standard deviations of various subgroups identical. The normalized score of an alternative in a subgroup is used as an overall score, which is used to sort the overall ranking of all alternatives.

However, such an approach is based on the assumption that evenness in various subgroups' alternatives can be achieved in the generation of subgroups, because the approach will treat the alternatives at the same ranking position in different subgroups equal. An alternative is compared with the alternatives which are in the same subgroup throughout all evaluation processes. Suppose the most several outstanding alternatives are assigned into the same subgroup. Using the method of the prior art, some of the outstanding alternatives may be ranked after commonplace alternatives which are from another subgroup. Thus, the commonly used approach could render a poor ranking result.

Thus, it is essential that the group of all alternatives is evenly divided into various subgroups based on the performances of alternatives. However, the problem is that the alternatives should be assigned into different subgroups before any evaluation result. The best to do is to randomize the process of subgroup assignments and hopefully the subgroups are as even as possible.

Therefore, it is desirable to provide a group decision method on ranking of a large number of alternatives to mitigate and/or obviate the afore-mentioned problems.

### SUMMARY OF THE INVENTION

An object of the present invention is to provide a group decision method on ranking of a large number of alternatives, which ranks the ranking number for each alternative, so as to increase the accuracy of ranking results of alternatives in a large scale competition

Another object of the present invention is to provide a group decision method on ranking of a large number of alternatives, which can be applied to ranking the students who apply for the admission to departments, ranking the alternatives in large scale competitions, ranking a large number of investment options (e.g., stocks selection), and ranking a large number of candidates in recruitment decision, which need to be divided into several subgroups for evaluation.

To achieve the object, the present invention provides a group decision method on ranking of a large number of alternatives, which is operated in a computer system including an input module for receiving information of multiple alternatives, a database module for storing the information of multiple alternatives, an output module, and a processing module coupled to the input module, the database module and the output module for executing the group decision method by performing a decision computation and outputting a decision result via the output module, the group decision method comprising the steps of: (A) initializing an iteration index to be one; (B) when the iteration index is equal to one, randomly dividing multiple alternatives into subgroups, and when the iteration index is not equal to one, re-grouping the multiple alternatives into subgroups; (C) ranking each alternative in every subgroup based on information of each alternative to generate a ranking number for each alternative in every subgroup; (D) determining a normalized score for each alternative in every subgroup; (E) when the iteration index i is not equal to a pre-determined number of iterations, incrementing the iteration index and executing step (B), and when the iteration index is equal to the pre-determined number of iterations, step (F) generating an average normalized score for each alternative and sorting all of the alternatives by average normalized scores of all of the alternatives to generate a final overall ranking result; and when the number of iterations is equal to the number subgroups, step (H) assigning the ranked alternatives to subsets and ranking alternatives of each subset to generate an additional final overall ranking result.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of a group decision method on ranking of a large number of alternatives according to the invention;

FIG. 2 is a schematic diagram of a computer system on which the group decision method according to the present invention is executed;

FIG. 3 is a schematic diagram illustrating that all alternatives are randomly assigned to subgroups in iteration 1 according to the invention;

FIG. 4 is a schematic diagram illustrating S evaluation processes to rank the S subgroups in a single iteration according to the invention;

FIG. 5 is a flowchart of detail steps in step (F) according to the invention;

FIG. 6 is a schematic diagram of the normalized scores according to the invention;

FIG. 7 is a flowchart of detail steps in step (B1) according to the invention;

FIG. 8 is a flowchart of detail steps in step (H) according to the invention;

FIG. 9 is a schematic diagram of parameter settings according to the invention;

FIG. 10A, FIG. 10B, and FIG. 10C illustrate the three subgroups after random grouping, the ranking of the alternatives in the three subgroup, and the normalized scores of all alternatives in iteration 1 according to the invention;

FIG. 11 is a schematic diagram of regrouping process by using regrouping procedure R_{1D} according to the invention;

FIG. 12A, FIG. 12B, and FIG. 12C illustrate the regrouping result, the ranking of the alternatives in the three subgroup, and the normalized scores of all alternatives in iteration 2 according to the invention;

FIG. 13 shows the regrouping details at the start of iteration 3 according to the invention;

FIG. 14A, FIG. 14B, and FIG. 14C illustrate the regrouping result, the ranking of the alternatives in the three subgroup, and the normalized scores of all alternatives in iteration 3 according to the invention;

FIG. 15 shows the evaluating result in three iterations and the gaps of all alternatives according to the invention; and

FIG. 16 shows an additional final overall ranking result of all alternatives obtained after the end of last iteration according to the invention.

### DETAILED DESCRIPTION OF THE PREFERRED EMBODIMENT

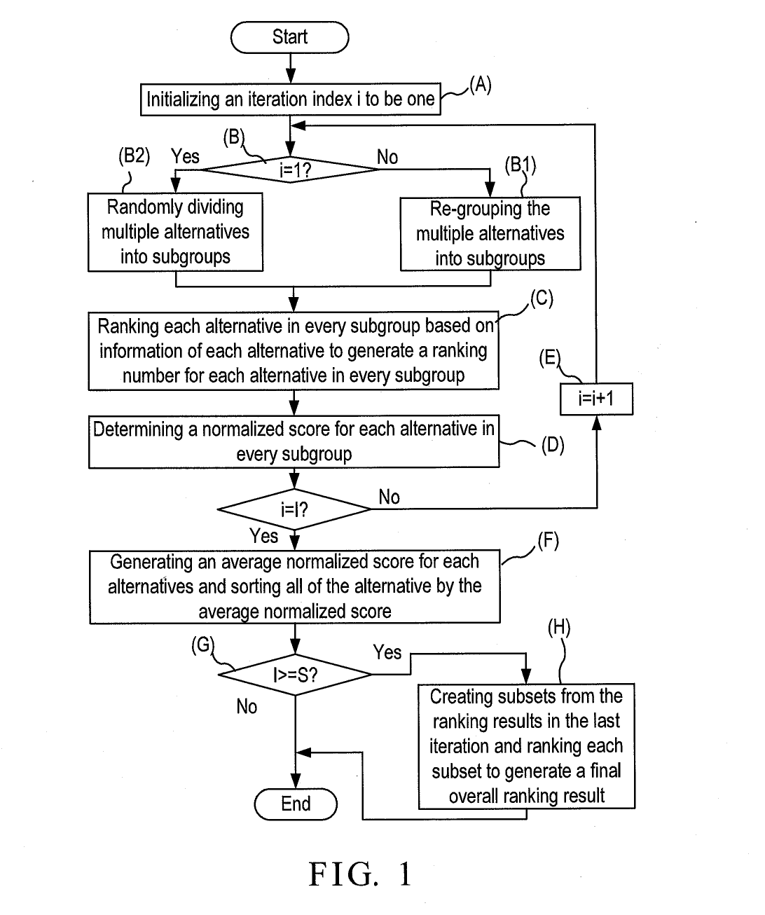

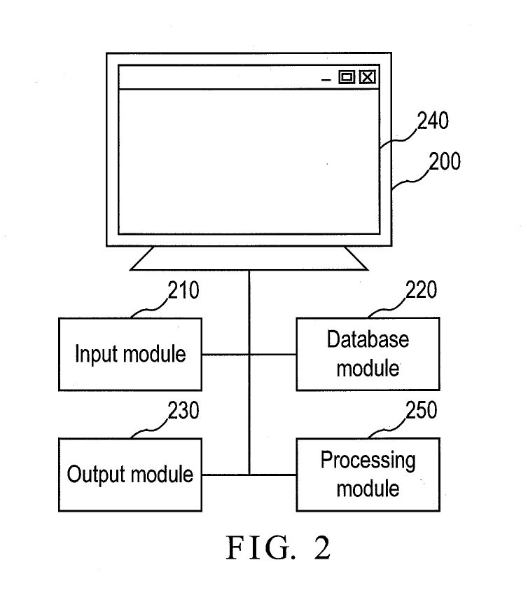

FIG. 1 is a flowchart of a group decision method on ranking of a large number of alternatives according to an embodiment of the invention. FIG. 2 is a schematic diagram of a computer system on which the group decision method according to the present invention is executed. The computer system 200 includes an input module 210, a database module 220, an output module 230, a display module 240, and a processing module 250. The input module is provided for receiving information of multiple alternatives, and the database module 220 stores the information of multiple alternatives. The processing module 250 is coupled to the input module 210, the database module 220 and the output module 230 for executing the group decision method by performing a decision computation and outputting a decision result via the output module 230.

In this embodiment, the input module 210 can be used to receive data, such as image, characters, instruction, video files, multi-media files, etc., and input the received data into the computer system 200. The database module 220 can be a hard drive, optical disc player, or a remote database through Internet connection to store system program, application program, user data, etc. The output module 230 is used to output the ranking result of a large number of alternatives, for example, to the display module 240.

In a large competition, there are many alternatives which normally have to be divided into a number of subgroups. When an overall ranking of all alternatives is needed, the most direct assumption is that the alternatives at the same ranking position in different subgroups are regarded to have equal performance. However, to make the assumption valid, it has to evenly assign the alternatives with the same performance level into different subgroups and each subgroup consists of alternatives with various levels. At the beginning of a competition, the information about alternative's actual ability is not known. Thus, one cannot divide the alternatives into subgroups according to their performance level.

The best it can do is to randomly divide alternatives into subgroups. However, it is not sure whether the evenness of subgroup assignment is achieved for a particular randomized grouping. Suppose alternatives are divided into three subgroups. The worst case scenario is that the best one third of the alternatives are assigned to the first subgroup; the next one third to the second subgroup; the worst one third to the third subgroup. By following the evenness assumption of grouping and treating the best alternative of each subgroup equally, it has the worst evaluation results in this case.

After a subgroup was evaluated, the alternative's ranking position in the subgroup can be regarded as the alternative's performance level. By using the ranking results, alternatives can be regrouped again. A new set of subgroups can be generated by using previous ranking results, and the alternatives with similar level of performances should be divided into different subgroups evenly.

The group decision method of the present invention is executed by performing a number of iterations. In the first iteration, the iteration index i is equal to one, alternatives are randomly divided into a number of subgroups, and then the ranking of alternatives in each subgroup are evaluated. In each iteration except the first one, the ranking results of previous iterations are used to regroup the alternatives in current iteration.

In an iteration, the ranking position number of an alternative is converted into a normalized score, which is between 0 and 1, for the alternative. After finishing all iterations, the normalized scores in all iterations of an alternative can be used to compute the average normalized score for the alternative.

The final overall ranking of all alternatives is obtained by sorting all the alternatives by the average normalized score.

If the number of iterations is greater than or equal to the number of subgroups, an additional final overall ranking result can also be obtained by assigning the ranked alternatives in each subgroup after the last iteration to a number of subsets and ranking the alternatives in each subset.

Let N be the number of alternatives and I be the number of iterations used in a competition. In each iteration, the alternatives are divided as equally as possible into S subgroups. The other required notations are in the following:

i: iteration number, i=1, 2, 3, . . . , I, where I is number of iterations;

s: subgroup number, s=1, 2, 3, . . . , S, where S is number of subgroups in each iteration;

r: alternative index number, r=1, 2, 3, . . . , N, where N is the number of the alternatives in the competition;

[r]: the index number of alternative which is in r-th position of the ranking sequence, r=1, 2, 3, . . . , N, where N is the number of the alternatives in the competition;

Pᵣ: the alternative with index number r;

Eₛⁱ: the index of the evaluation process assigned to subgroup s in iteration i;

nᵣⁱ: the number of alternatives in the subgroup that includes alternative r in iteration i;

Zₛⁱ: the number of alternatives in subgroup s in iteration i;

Gᵣⁱ: the subgroup that includes alternative r in iteration i;

Kᵣⁱ: the ranking number of alternative r in the alternative's subgroup in iteration i;

K̅ᵣⁱ: the overall ranking of alternative r when all iteration completed;

cᵣⁱ: the normalized score of the alternative r in iteration i;

c̅ᵣⁱ: the average normalized score of the alternative r of the previous i iteration;

W: the number of subsets for generating a final overall ranking, W is

$$⌊ \frac{N}{S} ⌋ + 1 ,$$

if the remainder of

$$\frac{N}{S}$$

is not zero; and W is

$$\frac{N}{S} ,$$

if the remainder of

$$\frac{N}{S}$$

is zero;

w: subset number or ranking number in a subgroup, w=1, 2, 3, . . . , W;

A_{[w]}^{s}: the alternative whose ranking number is w in subgroup s after executing the last iteration; that is, after the last iteration, in subgroup s, alternative A_{[w1]}^{s} outperforms alternative A_{[w2]}^{s}, if w1<w2; and

U_{w}: the subset w that includes all alternatives with ranking number w from all subgroups after the last iteration; that is, U_{w}={A_{[w]}¹, A_{[w]}², A_{[w]}³, . . . , A_{[w]}^{S}}.

As shown in FIG. 1, at first, the group decision method initializing an iteration index i to be one in step (A). Then, in step (B), it determines whether the iteration index i is equal to one or not. When the iteration index i is equal to one, it randomly divides multiple alternatives into subgroups in step (B2), and when the iteration index i is not equal to one, it re-groups the multiple alternatives into subgroups in step (B1).

In step (B2), the method is in the first iteration, all of the alternatives are randomly assigned into S subgroups. Subgroups 1, 2, . . . , a contain

$$⌊ \frac{N}{S} ⌋ + 1.$$

alternatives and subgroups a+1, a+2, . . . , S contain

$$⌊ \frac{N}{S} ⌋$$

alternatives, and a number of alternatives in subgroup s in iteration i is represented by Zₛⁱ, where └b┘ is a floor function and is defined as the largest integer that is smaller than or equal to b, a is a remainder of

$$\frac{N}{S}$$

and a≧0, N is number of the multiple alternatives, s is subgroup number, and S is number of subgroups. In iterations other than the first one, a regrouping method is used to re-assign each of the alternatives into one of the S subgroups.

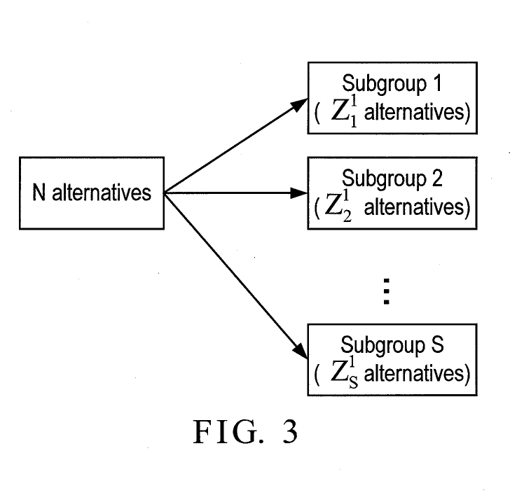

FIG. 3 is a schematic diagram of showing that all alternatives are randomly assigned to subgroups in iteration 1.

With reference to FIG. 1 again, in step (C), it ranks each alternative in every subgroup based on information of each alternative to generate a ranking number for each alternative in every subgroup. That is, in step (C), each alternative in every subgroup is assigned with the ranking number.

There are S subgroups, and thus the method performs S evaluation processes in an iteration. Normally, to reduce the workload in evaluation process, a subgroup is ranked in one evaluation process during the whole evaluation process. That is, the total number of evaluation processes required in the whole process is I×S.

If the current evaluation process refers to the evaluation results of previous evaluation processes, it makes final results dominated by the previous evaluation processes. One of the objectives of the overall evaluation process is to avoid the result being dominated by few evaluation processes. Therefore, the current evaluation process does not refer to the evaluation result of previous evaluation processes.

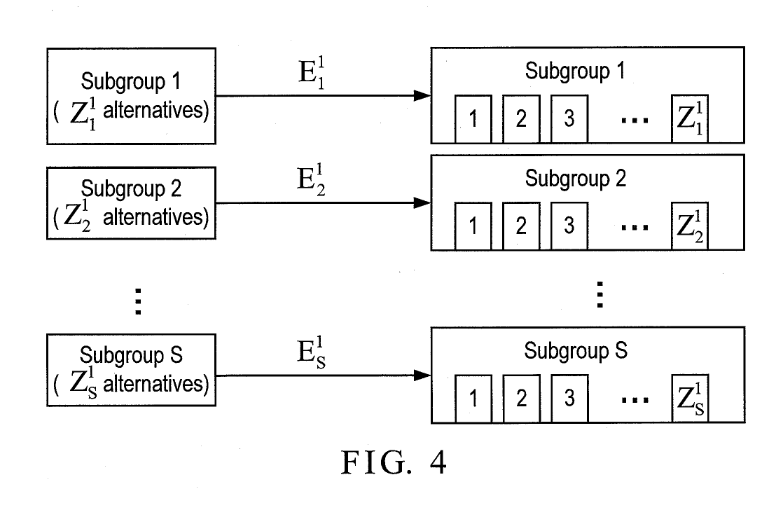

FIG. 4 is a schematic diagram of illustrating that, in a single iteration, there are S evaluation processes to rank the S subgroups. In different subgroups, each evaluation process has to assign each alternative a ranking number in the subgroup.

With reference to FIG. 1 again, in step (D), it determines a normalized score for each alternative in every subgroup based on the ranking number for each alternative in every subgroup.

Intuitively, the normalized scores of two best alternatives in two subgroups with different numbers of alternatives should not be equal. The best alternative in a larger subgroup should have a better score than the best alternative in a smaller subgroup. Similarly, the alternative ranked last in a larger subgroup should have worse score than the alternative ranked last in a smaller subgroup.

Due to different numbers of alternatives in various subgroups, the following formula is used to convert a ranking number in a subgroup into a normalized score after the ranking of a subgroup is determined by an evaluation process. The normalized score of alternative r with ranking position (or ranking number) Kᵣⁱ in a subgroup in iteration i is calculated by the following equation (1):

$${c}_{r}^{i} = \frac{1 + [ 2 \times ( {K}_{r}^{i} - 1 ) ]}{2 \times {n}_{r}^{i}} , \qquad ( 1 )$$

where cᵣⁱ is the normalized score, Kᵣⁱ is the ranking number of alternative r in subgroup in iteration i, and nᵣⁱ is number of alternatives in the subgroup that includes alternative r in iteration i.

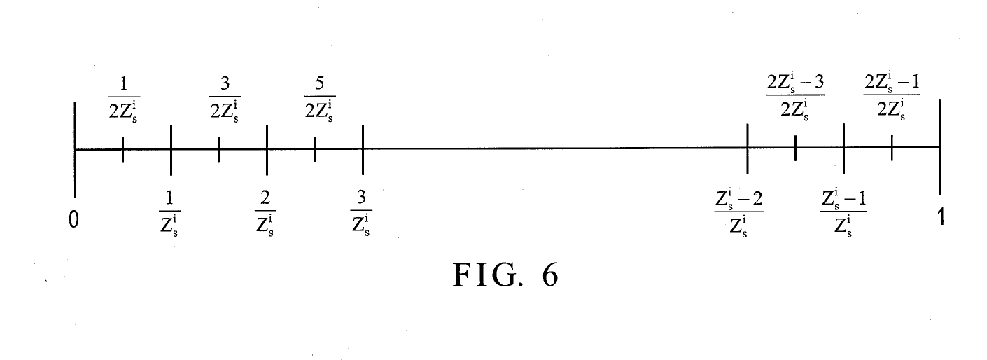

Note that the set of rankings in subgroup s in iteration i is {1, 2, . . . , Zₛⁱ}. The idea of the equation (1) is that it evenly divides the scale between 0 and 1 into a number of portions, which equals to the number of alternatives in a subgroup. The middle point of each divided portion is used as the score of an alternative that is assigned to the ranking position. FIG. 6 is a schematic diagram of the normalized scores according to the invention. FIG. 6 shows the idea of the equation (1) that calculates the normalized scores of the alternatives with ranking positions in a subgroup containing Zₛⁱ alternatives.

The evaluation process consists of I iterations, and each of the iterations includes the three steps described above.

With reference to FIG. 1 again, in step (B1), the multiple alternatives are re-grouped into subgroups. To make a good use of the information provided by the ranking decisions of the previous iterations, the proposed procedure uses the previous iterations' ranking results to regroup the alternatives in the current iteration and try to equalize the overall alternatives' performances of each subgroup.

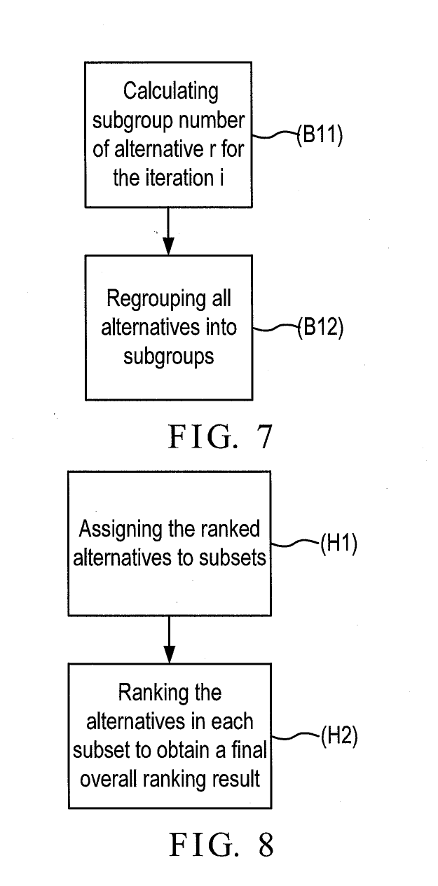

The regrouping procedure mainly includes two phases. FIG. 7 is a flowchart of detail steps in step (B1) of the present invention. In step (B11), it calculates subgroup number of alternative r for the iteration i. That is, alternatives are regrouped into S subgroups based on the following equation (2):

Gᵣⁱ=1+{[(Gᵣⁱ⁻¹−1)+(Kᵣⁱ⁻¹−1)]%S}, (2)

where % is defined as an operator for calculating a remainder of division of two integers, Gᵣⁱ is a subgroup that includes alternative r in iteration i, and Gᵣⁱ⁻¹ is a subgroup that includes alternative r in iteration i−1.

This re-grouping procedure is denoted as R_{1D} which represents using the ranking result of one previous iteration and regrouping deterministically.

In step (B12), all alternatives are re-grouped into new subgroups.

With reference to FIG. 1 again, in step (E), when the iteration index i is not equal to a pre-determined number of iterations I, it increases the iteration index and executing step (B), and when the iteration index i is equal to the pre-determined number of iterations I, executing step (F).

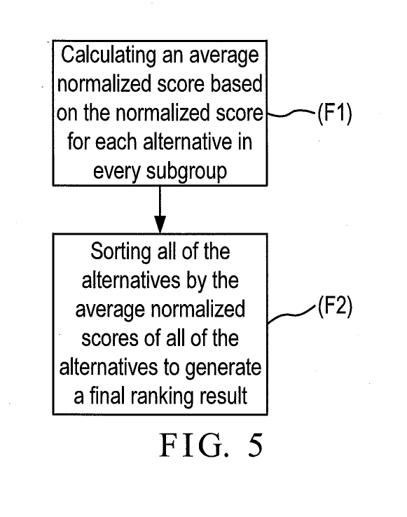

FIG. 5 is a flowchart of detail steps in step (F) of the present invention. In step (F1), it calculates an average normalized score of each alternative based on all of the alternative's normalized scores obtained in previous iterations. The average normalized score of an alternative is calculated by averaging up the normalized scores from all iterations of the alternative. That is, the average normalized score of alternative r is

$${\overline{c}}_{r}^{I} = \frac{{\sum }_{i = 1}^{I} {c}_{r}^{i}}{I} ,$$

where c̅ᵣ^{I} is the average normalized score, cᵣⁱ is the normalized score, and I is the pre-determined number of iterations.

In step (F2), it sorts all of the alternatives by the average normalized scores of all of the alternatives to generate a final overall ranking result. That is, the final overall ranking result is obtained by sorting all the alternatives based on the average normalized score.

After executing step (F), in step (G), it checks whether the number of iterations I is greater than or equal to the number of subgroups S. If the number of iterations I is greater than or equal to the number of subgroups S, an addition final overall ranking result can be obtained by executing step (H). The partial ranking results in all subgroups of the last iteration provide us very good information to generate a final overall ranking result. This is done by assigning the alternative with ranking number w in each subgroup to subset U_{w}. There are at most S alternatives in a subset. Be more specific, the alternative with ranking number 1 in each subgroup is assigned to the first subset U₁, the alternative with ranking number 2 in each subgroup is assigned to the second subset U₂, and so on. In this way, if w1<w2, the final overall ranking of all of the alternatives in subset U_{w1} are higher (with a smaller ranking number) than all of the alternatives in subset U_{w2}. In addition, the ranking of the alternatives within a subset can be easily performed, since there are at most S alternatives, where S is normally a very small number. The execution of step (H) can be outlined as follows. In step (H1), for each w=1, 2, . . . , W in each subgroup after the last iteration, assign the alternative with ranking number w in its subgroup to subset U_{w}. Then, U_{w} contains the all the alternatives with ranking number w in their subgoups. In step (H2), for each w=1, 2, . . . , W, the alternatives with final overall ranking number between [S(w−1)+1, Sw] are obtained by ranking the alternatives in subset U_{w}. Be more specific, the alternatives with the final overall ranking numbers from 1 to S are obtained by ranking the alternatives in subset U₁; the alternatives with the final overall ranking numbers from S+1 to 2S is obtained by ranking the alternatives in subset U₂; the alternatives with the final overall ranking numbers from 2S+1 to 3S are obtained by ranking the alternatives in subset U₃; and so on.

An example is presented to illustrate the group decision method of the present invention. Given the same group of alternatives, it is most likely that different evaluation processes rank these alternatives subjectively and provide different ranking result, because different standards or preferences could be adopted by various evaluation processes. Suppose there is a consensus on the ranking of alternatives among all possible evaluation processes and we call such a ranking as perfect ranking in this invention. Another objective of this example is to demonstrate how well the proposed group decision method can re-generate the consensus ranking.

Denote the alternatives with perfect ranking 1, 2, . . . , N as P_{[1]}, P_{[2]}, . . . , P_{[N]}. In this example, without loss of generality, it assumes Pᵣ=P_{[r]}, that is, alternative r will be ranked in r-th position in perfect ranking. Also, this example does not consider the noises in the preference differences among evaluation processes. Thus, a subgroup will be ranked in an evaluation process according to the perfect rankings. That is, P_{[r1]} will be ranked higher than P_{[r2]} by all evaluation processes, if r1<r2.

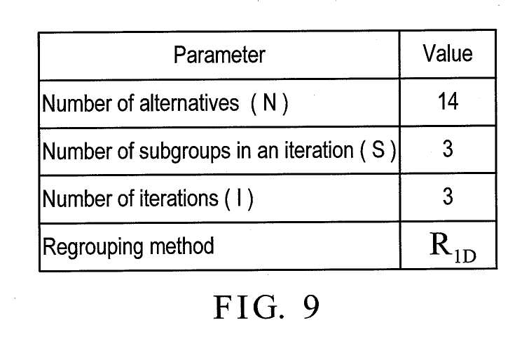

In this example, 14 alternatives are divided into 3 subgroups in each iteration, and 3 iterations are performed with the regrouping method. FIG. 9 is a schematic diagram of parameter settings according to the invention. Since the alternatives are divided into three subgroups, three evaluation processes are required in each iteration. Totally, nine evaluation processes are required to complete the procedure.

In iteration 1, the 14 alternatives are randomly divided into three subgroups. In this example, through a randomization procedure, suppose P_{[13]}, P_{[4]}, P_{[1]}, P_{[2]}, P_{[11]} are assigned to subgroup 1, and P_{[8]}, P_{[7]}, P_{[6]}, P_{[3]}, P_{[12]} to subgroup 2, and P_{[9]}, P_{[5]}, P_{[10]}, P_{[14]} to subgroup 3. An evaluation process will be given a task of ranking a subgroup and, since there is a perfect ranking, the evaluation process will rank the subgroup according to the perfect ranking. P_{[r1]}>P_{[r2]} denotes that alternative r1 is ranked higher than alternatives r2. Thus, ranking result of subgroup 1 is P_{[1]}>P_{[2]}>P_{[4]}>P_{[11]}>P_{[13]}. Similarly, the ranking result of subgroup 2 is P_{[3]}>P_{[6]}>P_{[7]}>P_{[8]}>P_{[12]}, and subgroup 3 is P_{[5]}>P_{[9]}>P_{[10]}>P_{[14]}.

After all subgroups being ranked, the ranking of an alternative in a subgroup will be transformed into a normalized score by using equation

$${c}_{r}^{i} = \frac{1 + [ 2 \times ( {K}_{r}^{i} - 1 ) ]}{2 \times {n}_{r}^{i}} .$$

Thus, P_{[1]} and P_{[3]} are both ranked 1st in the respective subgroup of 5 alternatives, so that the normalized score is

$$\frac{1 + [ 2 \times ( 1 - 1 ) ]}{2 \times 5} = 0.1 .$$

P_{[5]} is ranked 1st in the smaller subgroup with only four alternatives, so the normalized score is

$$\frac{1 + [ 2 \times ( 1 - 1 ) ]}{2 \times 4} = 0.125 .$$

The normalized score of other alternatives can be calculated by using the same equation.

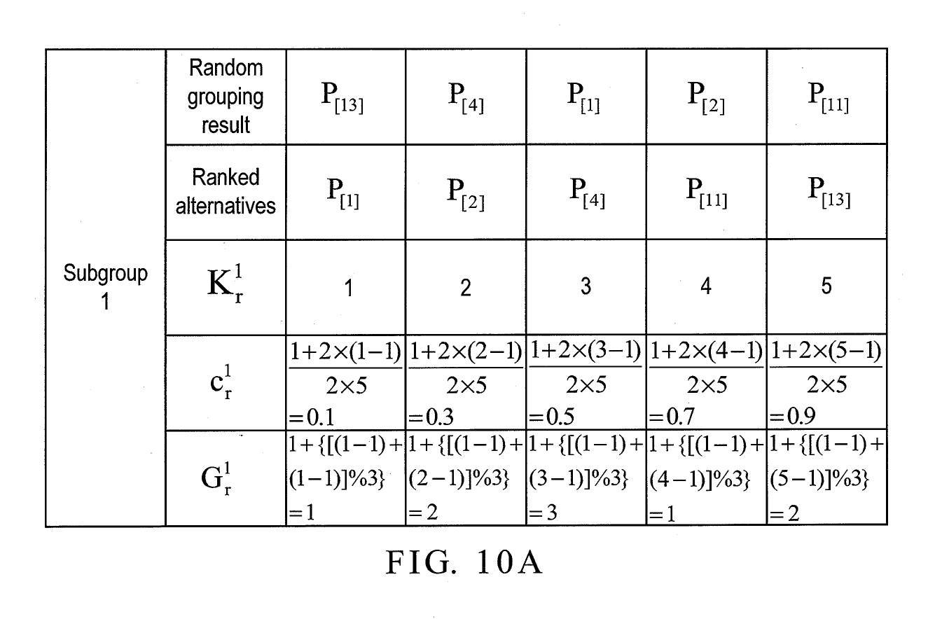

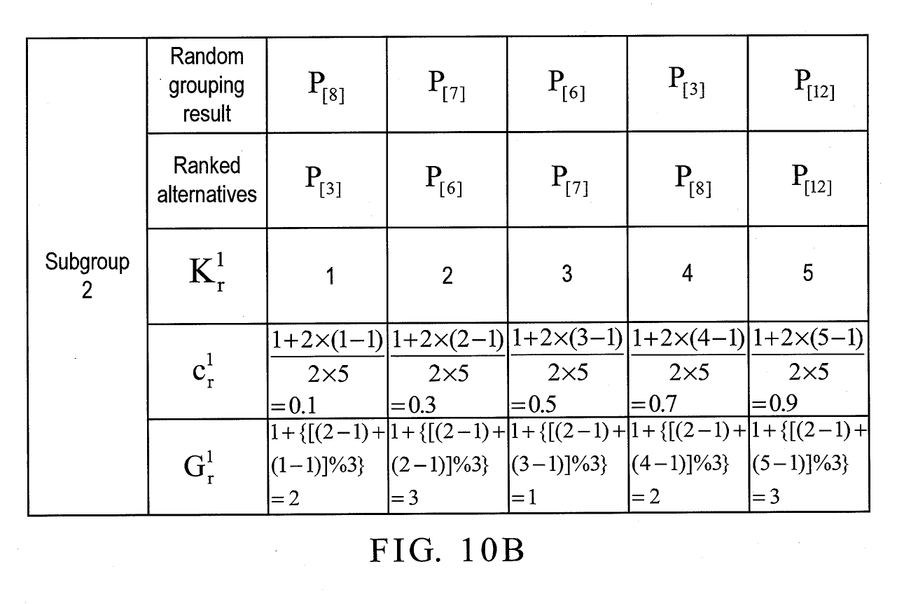

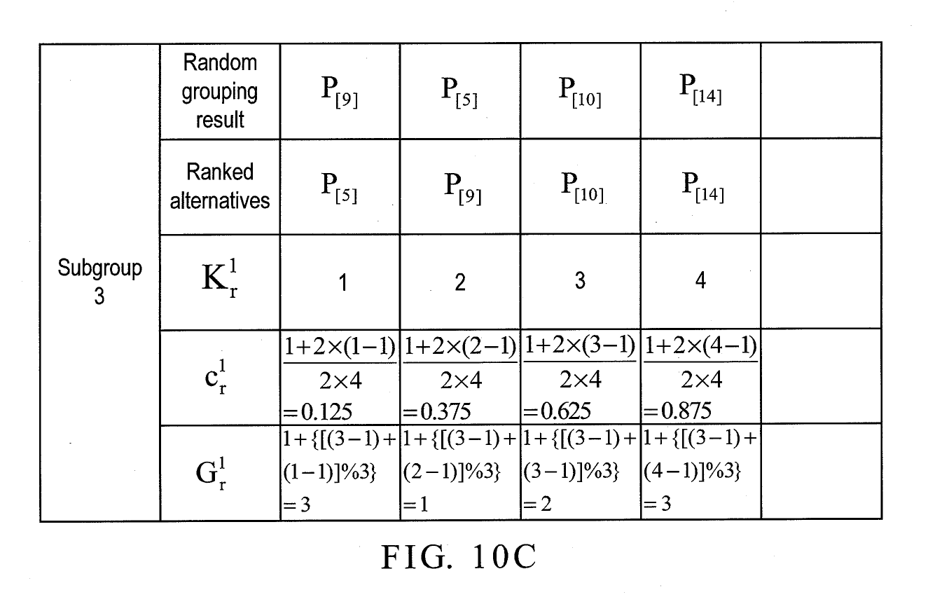

FIG. 10A, FIG. 10B, and FIG. 10C illustrate the three subgroups after random grouping, the ranking of the alternatives in the three subgroup, and the normalized scores of all alternatives in iteration 1 according to the invention.

The rankings in iteration 1 are used to regroup the alternatives in iteration 2. The alternatives are regrouped by using the regrouping procedure R_{1D}. The subgroup number of each alternative in iteration 2 is calculated by Gᵣ²=1+{[(Gᵣ¹−1)+(Kᵣ¹−1)]%3}.

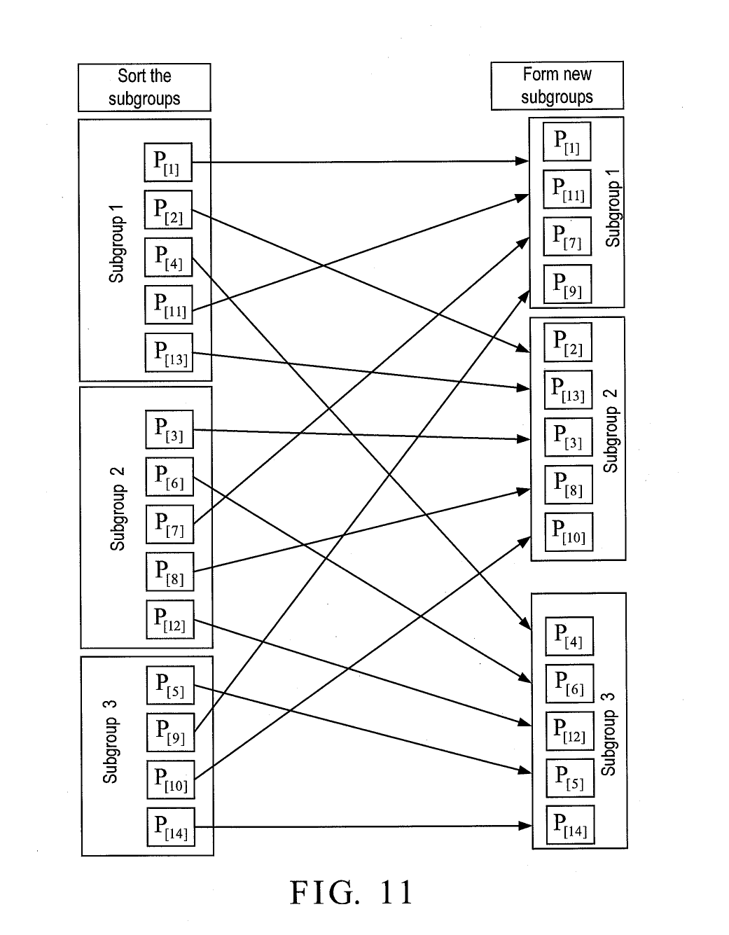

As shown in FIG. 10A, FIG. 10B, and FIG. 10C, for instance, the ranking number of P_{[13]} is 5, and P_{[13]} is in subgroup 1 in iteration 1, so that P_{[13]} is assigned to subgroup 2(=1+{[(1−1)+(5−1)]%3}) in iteration 2. FIG. 11 is a schematic diagram of regrouping process by using regrouping procedure R_{1D} according to the invention. As shown in FIG. 11, it shows regrouping result based on regrouping procedure R_{1D} at the start of iteration 2.

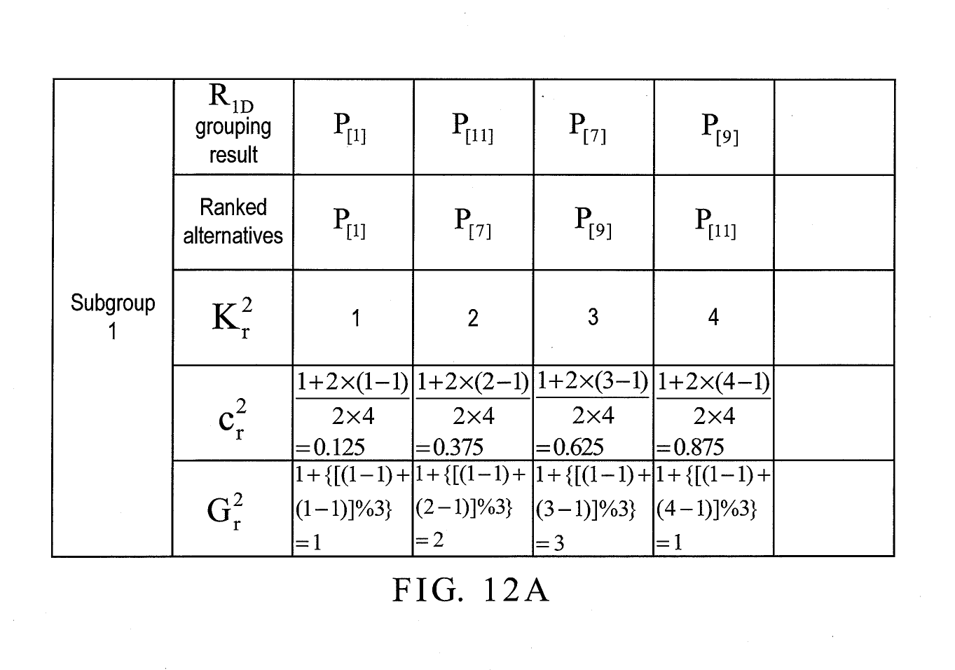

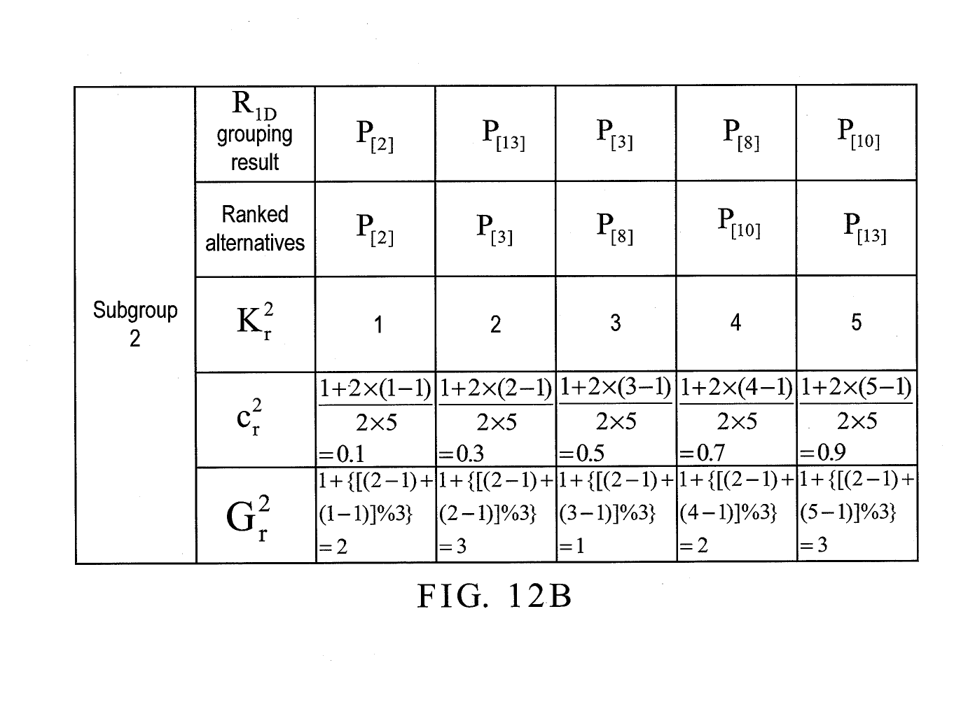

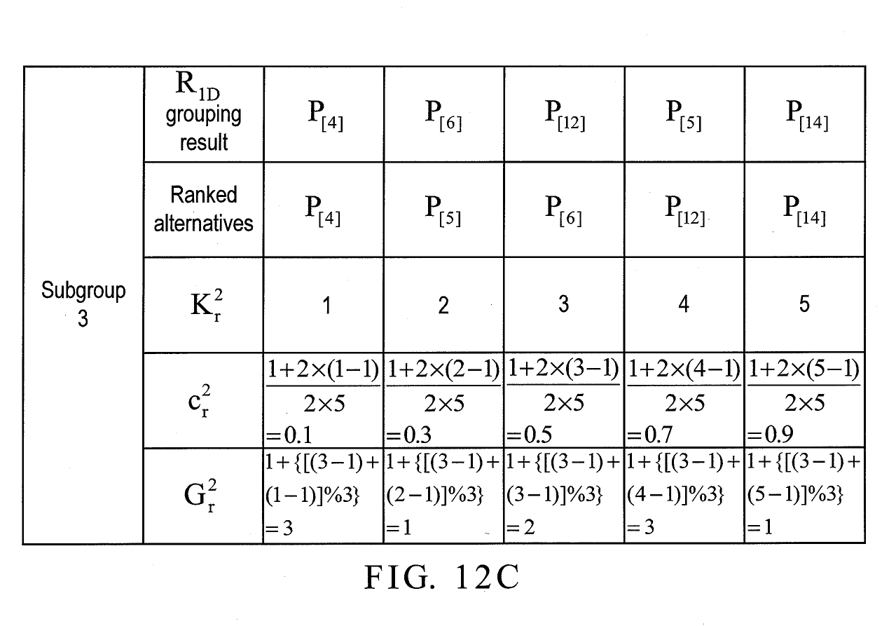

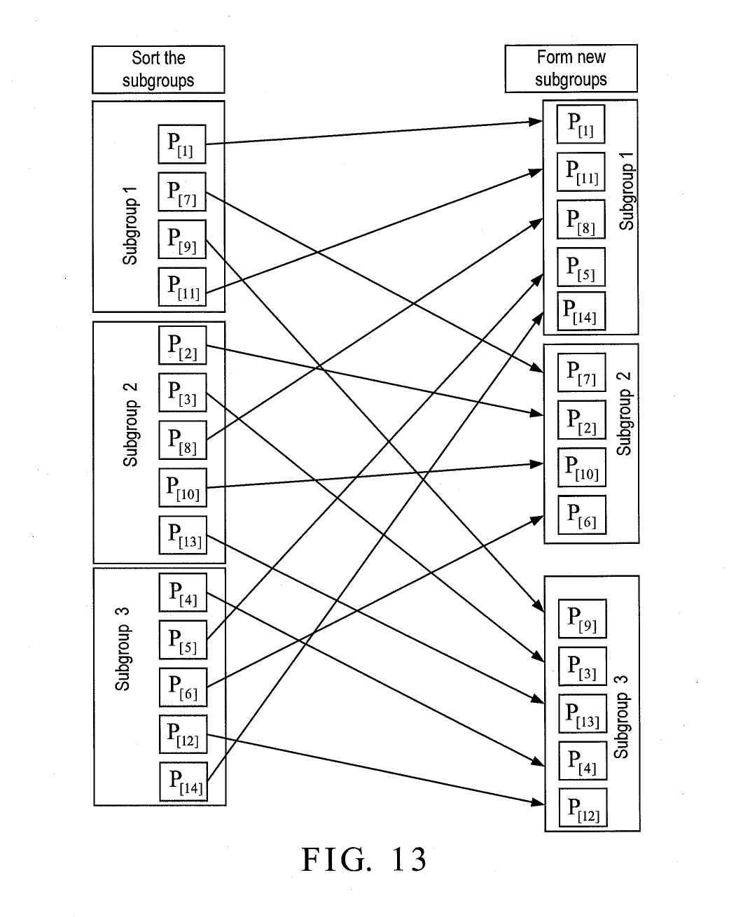

After regrouping the alternatives, three more evaluation processes are assigned to rank the three subgroups in iteration 2. FIG. 12A, FIG. 12B, and FIG. 12C illustrate the regrouping result and evaluating result of alternatives in iteration 2 according to the invention. FIG. 13 shows the regrouping details at the start of iteration 3.

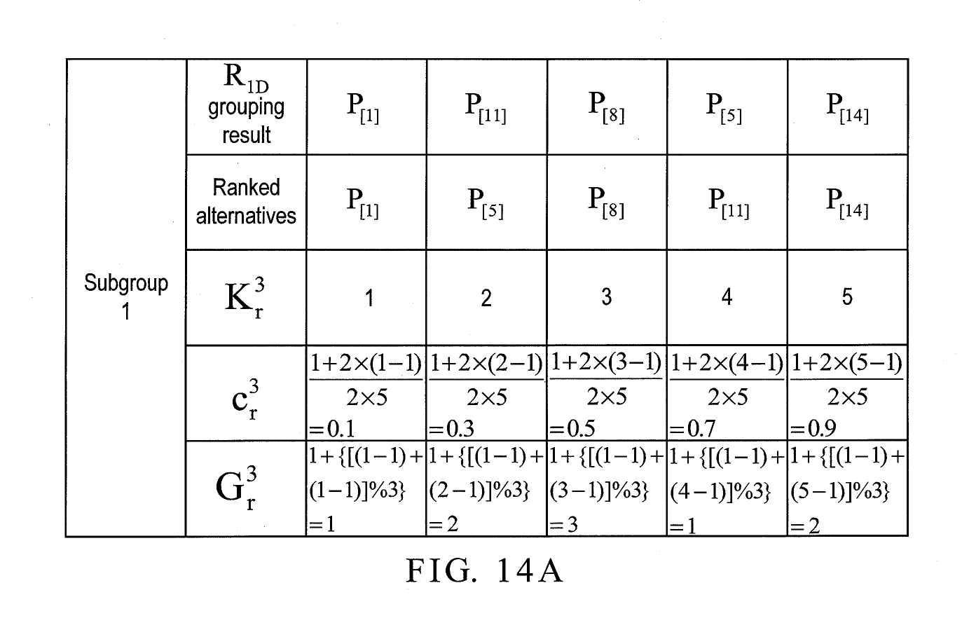

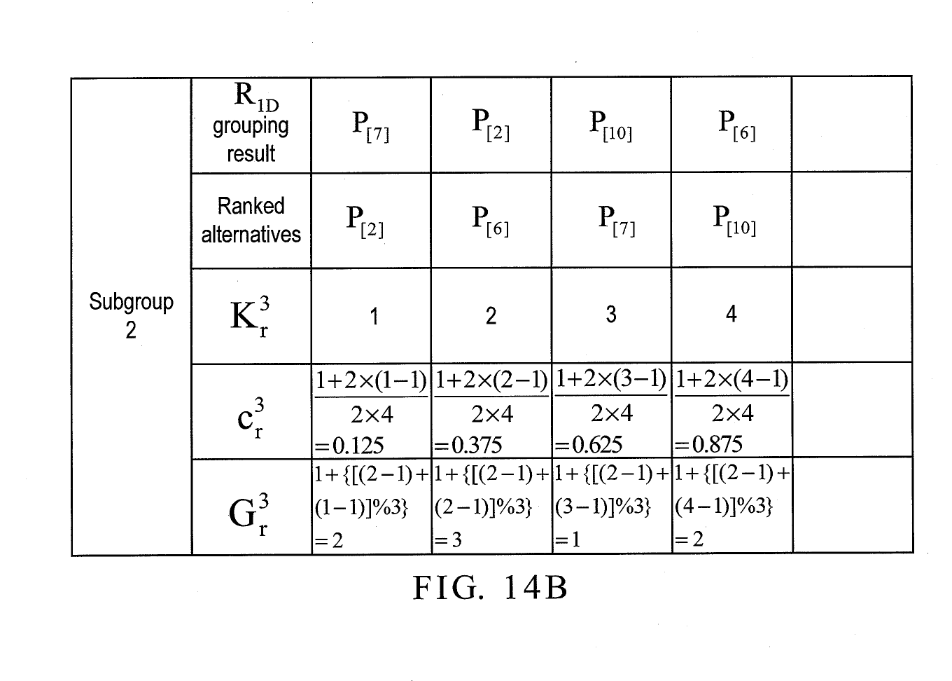

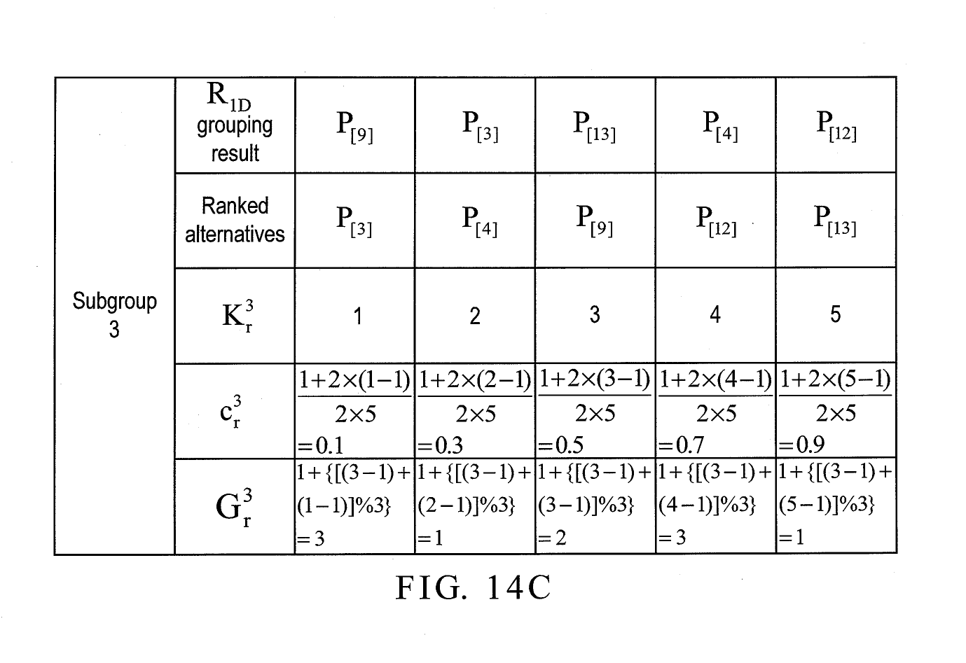

In the last evaluation iteration, three new subgroups are ranked by three more evaluation processes. FIG. 14A, FIG. 14B, and FIG. 14C illustrate alternative's normalized scores by transforming their ranking position number within their subgroups.

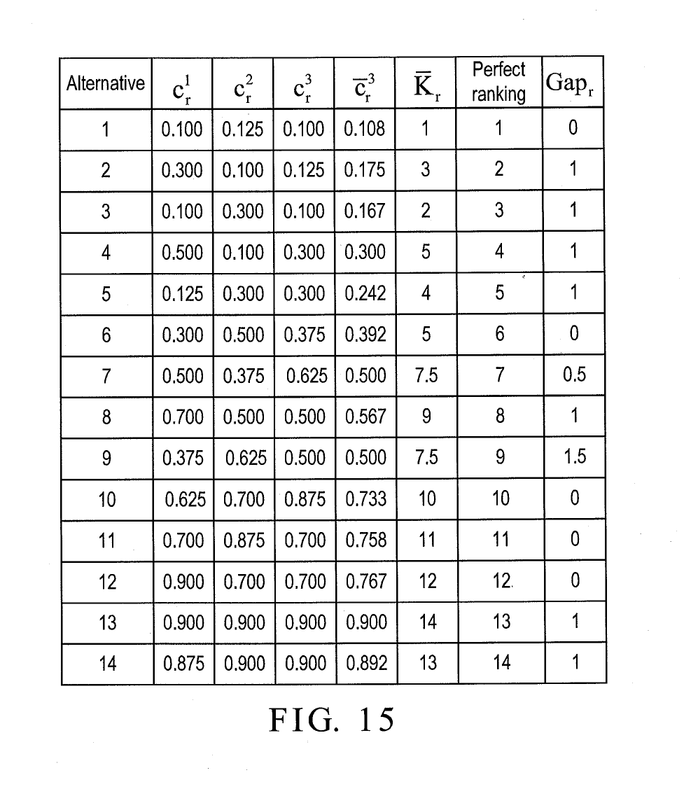

After completing three iterations, all alternatives are ranked by three different evaluation processes. The overall rankings can be generated by sorting the average normalized scores C̅ᵣ³ of the three iterations. It defines the gap as the difference between the ranking number of an alternative by using the group decision method of the invention and the alternative's perfect ranking number, i.e, | K̅_{[r]}−r|. A smaller gap implies that the procedure can re-generate the perfect rankings of the alternatives more accurately. FIG. 15 shows the evaluating result in three iterations and the gaps of all alternatives.

Suppose there exists a perfect ranking. If all alternatives can be evaluated in one evaluation process, the average gap is 0. However, in large scale competitions, only a portion of all alternatives can be evaluated in one evaluation process. The gap represents the error of re-creating the original perfect ranking. Through the group decision method of the invention, the average gap is merely 0.571. Therefore, if an alternative's ranking is r in a perfect ranking, on average, the alternative's ranking becomes r±0.571 after being evaluated by the group decision method. Thus, the group decision method is able to sufficiently accurately re-generate the perfect ranking, if there is one.

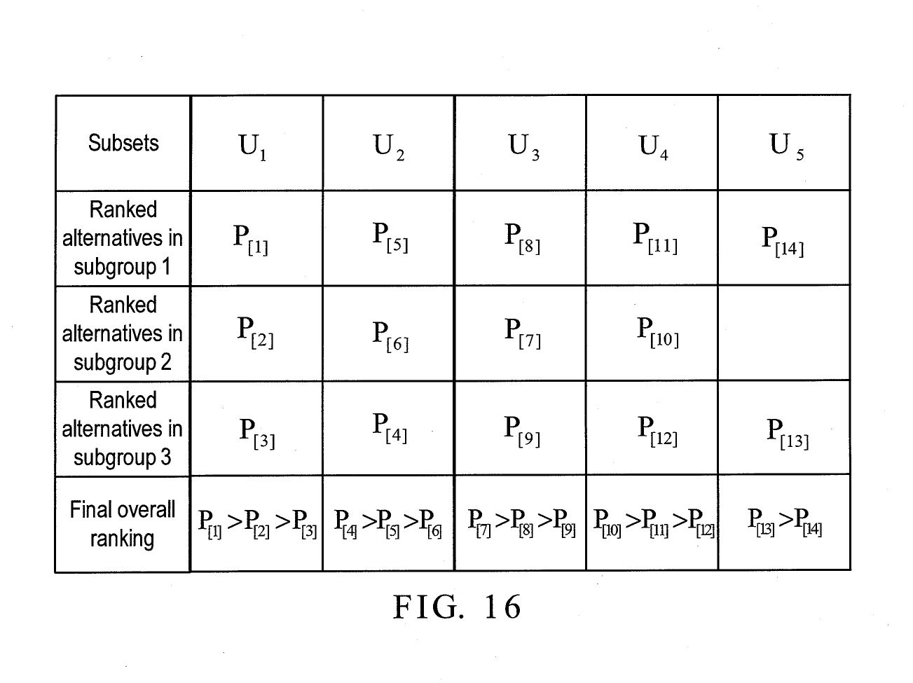

In this example, since the number of iterations I is greater than or equal to the number of subgroup S, an additional final overall ranking result can be obtained as illustrated in FIG. 16. The ranking results of subgroups 1, 2, and 3 after the last iterations are shown in rows 2, 3 and 4, respectively, in the figure, which are duplicated from FIG. 14A, FIG. 14B, and FIG. 14C, respectively. The subset U₁ contains the alternatives with ranking number 1 in their subgroups; that is, P_{[1]} of subgroup 1, P_{[2]} of subgroup 2, and P_{[3]} of subgroup 3 are assigned to U₁. In sum, U₁={P_{[1]}, P_{[2]}, P_{[3]}}. Similarly, subsets U₂, U₃, U₄, and U₅ can be generated. Each subset U_{w} is corresponding to a column in FIG. 16. After ranking the alternatives in U₁, the overall ranking between [1,3] can obtained. That is, the final overall ranking number of P_{[1]} is set at 1; the final overall ranking number of P_{[2]} is set at 2; the final overall ranking number of P_{[3]} is set at 3. Similarly, the alternatives ranked between [4,6], [7,9], [10,12], and [13,14] can obtained by ranking the alternatives in U₂, U₃, U₄, and U₅, respectively. Observing the final overall ranking result shown in FIG. 16, the perfect ranking is obtained by ranking these subsets.

According to the above description, in a large competition, the number of alternatives is too large to be reviewed in an evaluation process to rank all the alternatives. The group decision method provides a solution to resolve this issue by suggesting a cooperative ranking procedure whose objective is to generate a ranking result as close to perfect ranking as possible. The method which utilizes ranking result from one previous iteration and uses deterministic selecting scheme denoted as R_{ID} is suggested to be used due to its easy implementation and its ability to reduce error within a small number of iterations, usually three iterations.

The method of the invention can be applied to ranking the students who apply for the admission to departments, ranking the participants in large scale competitions, ranking a large number of investment options (e.g., stocks selection), and ranking a large number of candidates in recruitment decision, which need to be divided into several subgroups for evaluation.

According to the above description, the present invention randomly divides multiple alternatives into subgroups or re-groups the multiple alternatives into subgroups, ranks each alternative in every subgroup based on information of each alternative to generate a ranking number for each alternative in every subgroup, then determines a normalized score for each alternative in every subgroup to generate an average normalized score for each alternative. Therefore, it can increase the accuracy of ranking results of alternatives in a large scale competition. Further, the problem of outstanding alternatives in a subgroup may be ranked after commonplace alternatives in another subgroup could be avoided.

Although the present invention has been explained in relation to its preferred embodiment, it is to be understood that many other possible modifications and variations can be made without departing from the spirit and scope of the invention as hereinafter claimed.

What is claimed is:

1. A group decision method on ranking of a large number of alternatives, which is operated in a computer system including an input module for receiving information of multiple alternatives, a database module for storing the information of multiple alternatives, an output module, and a processing module coupled to the input module, the database module and the output module for executing the group decision method by performing a decision computation and outputting a decision result via the output module, the group decision method comprising the steps of:
(A) initializing an iteration index to be one;
(B) when the iteration index is equal to one, randomly dividing multiple alternatives into subgroups, and when the iteration index is not equal to one, re-grouping the multiple alternatives into subgroups;
(C) ranking each alternative in every subgroup based on information of each alternative to generate a ranking number for each alternative in every subgroup;
(D) determining a normalized score for each alternative in every subgroup;
(E) when the iteration index i is not equal to a pre-determined number of iterations, incrementing the iteration index and executing step (B), and when the iteration index is equal to the pre-determined number of iterations, executing step (F); and
(F) generating an average normalized score for each alternative and sorting all of the alternatives by the average normalized scores of all of the alternatives to generate a final overall ranking result.

2. The group decision method as claimed in claim 1, wherein, in step (B) for randomly dividing multiple alternatives into subgroups, all of the alternatives are randomly assigned into S subgroups, in which subgroups 1, 2, . . . , a contain
$$⌊ \frac{N}{S} ⌋ + 1.$$
alternatives and subgroups a+1, a+2, . . . , S contain
$$⌊ \frac{N}{S} ⌋$$
alternatives, and a number of alternatives in subgroup s in iteration i is represented by Zₛⁱ, where └b┘ is a floor function and is defined as the largest integer that is smaller than or equal to b, a is a remainder of
$$\frac{N}{S} and a \geq 0 ,$$
N is number of the multiple alternatives, s is subgroup number, and S is a number of subgroups.

3. The group decision method as claimed in claim 2, wherein, in step (C), each alternative in every subgroup is assigned with the ranking number.

4. The group decision method as claimed in claim 3, wherein, step (D), the normalized score based on the ranking number for each alternative in every subgroup is calculated.

5. The group decision method as claimed in claim 4, wherein step (F) comprises the steps of:
(F1) calculating an average normalized score based on the normalized score for each alternative in every evaluation process; and
(F2) sorting all of the alternatives by the average normalized scores of all of the alternatives to generate a final overall ranking result.

6. The group decision method as claimed in claim 5, wherein the normalized score is calculated by equation:
$${c}_{r}^{i} = \frac{1 + [ 2 \times ( {K}_{r}^{i} - 1 ) ]}{2 \times {n}_{r}^{i}}$$
where cᵣⁱ is the normalized score, Kᵣⁱ is the ranking number of alternative r in subgroup in iteration i, nᵣⁱ is number of alternatives in the subgroup that includes alternative r in iteration i.

7. The group decision method as claimed in claim 6, wherein the average normalized score is calculated by equation:
$${\overline{c}}_{r}^{I} = \frac{{\sum }_{i = 1}^{I} {c}_{r}^{i}}{I} ,$$
where c̅ᵣ^{I} is the average normalized score, cᵣⁱ is the normalized score, and I is the pre-determined number of iterations.

8. The group decision method as claimed in claim 7, wherein in step (B), re-grouping the multiple alternatives into subgroups comprises the steps of:
(B11) calculating new subgroup number of alternative r for the iteration i; and
(B12) regrouping all alternatives into subgroups.

9. The group decision method as claimed in claim 8, regrouping alternatives into S subgroups is based on equation:
Gᵣⁱ=1+{[(Gᵣⁱ⁻¹−1)+(Kᵣⁱ⁻¹−1)]% S},
where % is defined as an operator for calculating a remainder of division of two integers, Gᵣⁱ is a subgroup that includes alternative r in iteration i, Gᵣⁱ⁻¹ is a subgroup that includes alternative r in iteration i−1.

10. The group decision method as claimed in claim 1, further comprising the step of:
(G) when the predetermined number of iterations is less than the number of subgroups, ending the group decision method, and when the predetermined number of iterations is greater than or equal to the number of subgroups, executing step (H); and
(H) assigning the alternatives based ranking numbers in their subgroup after the last iteration to subsets and generating a final overall ranking result.

11. The group decision method as claimed in claim 10, wherein in step (H) comprises the steps of:
(H1) for each w=1, 2, . . . , W in each subgroup after the last iteration, assigning the alternative with ranking number w in the subgroup to subset U_{w}; and,
(H2) for each w=1, 2, . . . , W, ranking the alternatives in U_{w} and setting the ranked alternatives with final overall ranking numbers between [S(w−1)+1, Sw] consecutively;
where w is a ranking number within a subgroup, S is the number of subgroups, W is the maximum number of alternative in a subgroup, U_{w} is a subset of alternatives whose ranking number is w in their subgroup in the last iteration.
